(19) United States
(12) Patent Application Publication
(10) Pub. No.: US 2009/0266623 A1
(43) Pub. Date: Oct. 29, 2009

(54) REMOTE SENSING CONTROLLER

(75) Inventors: Chih-Wei Wang, Zhonghe City (TW); Yuh-Chang Hsu, Yilan County (TW); Kun-Feng Cheng, Taipei (TW)

Correspondence Address: PAI PATENT & TRADEMARK LAW FIRM, 1001 FOURTH AVENUE, SUITE 3200, SEATTLE, WA, 98154, US

(73) Assignee: Chih-Wei Wang, Zhonghe City (TW)

(21) Appl. No.: 12/431,226

(22) Filed: Apr. 28, 2009

(30) Foreign Application Priority Data
Apr. 28, 2008 (TW) 97115563

(51) Int. Cl. G06F 3/041

(52) U.S. Cl. 178/18.03

(57) ABSTRACT

A remote sensing controller having a detection area, wherein the remote sensing controller comprises: a plurality of electromagnetic wave generators, a sensor, a determining module and a controlling module. The plurality of electromagnetic wave generators are to generate an electromagnetic wave respectively, wherein at least one reflected electromagnetic wave is further generated according to the reflection of the plurality of electromagnetic waves from an object within the detection area, wherein the number of the reflected electromagnetic wave is related to a displacing condition of the object. The sensor is to sense the reflected electromagnetic wave to generate a sensing result. The determining module is to determine the displacing condition of the object according to the sensing result. And the controlling module is to generate a command corresponding to the displacing condition according to a relation table and further control at least one external electronic device according to the command.

### RELATED APPLICATIONS

This application claims priority to Taiwan Application Serial Number 97115563, filed Apr. 28, 2008, which is herein incorporated by reference.

### BACKGROUND

1. Field of Invention

The present invention relates to a remote sensing controller. More particularly, the present invention relates to a remote sensing controller having a detection area.

2. Description of Related Art

There are more and more different input methods provided for electronic devices in order to make the user control for electronic devices more convenient. The electromagnetic wave sensing device provides a convenient way to control the electronic device without any direct touch. However, each of the sensors of the conventional electromagnetic wave sensing device can only correspond to one electromagnetic wave generator. If a complex input method has to be used to control the electronic device, the number of the sensors and the generators will increase. Thus, the cost and the size of the electromagnetic wave sensing device will increase as well, which is an undesirable result.

Accordingly, what is needed is a remote sensing controller to use less generators and sensors to realize the complex input method to lower the cost and the size of the device. The present invention addresses such a need.

### SUMMARY

A remote sensing controller having a detection area is provided. The remote sensing controller comprises: a plurality of electromagnetic wave generators, a sensor, a determining module and a controlling module. The plurality of electromagnetic wave generators are to generate an electromagnetic wave respectively, wherein at least one reflected electromagnetic wave is further generated according to the reflection of the plurality of electromagnetic waves from an object within the detection area, wherein the number of the reflected electromagnetic wave is related to a displacing condition of the object. The sensor is to sense the reflected electromagnetic wave to generate a sensing result. The determining module is to determine the displacing condition of the object according to the sensing result. And the controlling module is to generate a command corresponding to the displacing condition according to a relation table and further control at least one external electronic device according to the command.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1A is a block diagram of a remote sensing controller of the first embodiment of the present invention;

FIG. 1B is another block diagram of the remote sensing controller of the first embodiment of the present invention;

FIG. 2A depicts a displacing trajectory of an object from left to right and from right to left;

FIG. 2B depicts a rest position in of an object front of the electromagnetic generators;

FIG. 2C depicts a rest position of the object right in front of the sensor to block the sensor; and

FIG. 3 is the electromagnetic wave generators and sensor of the second embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

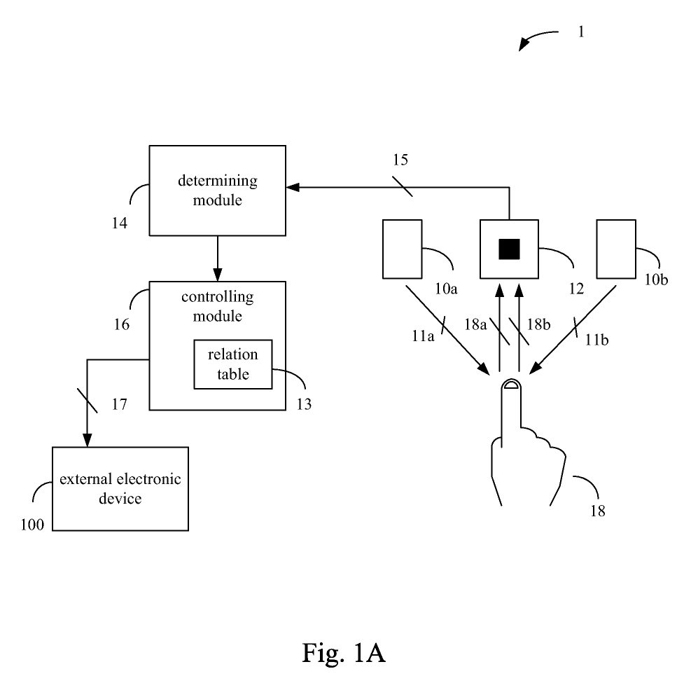

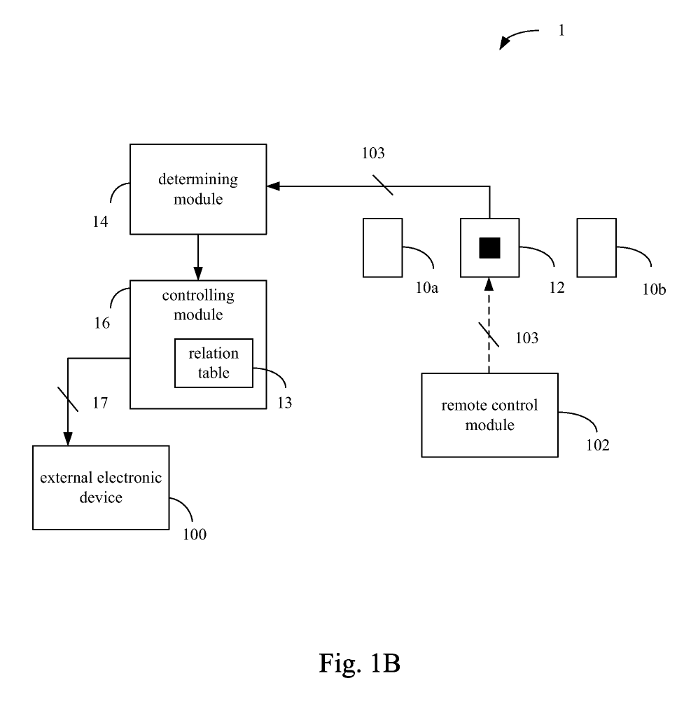

Please refer to FIG. 1A. FIG. 1A is a remote sensing controller 1 of the first embodiment of the present invention. The remote sensing controller 1 has a detection area (not shown). The remote sensing controller 1 performs the sensing mechanism within the detection area. The remote sensing controller 1 comprises: two electromagnetic wave generators 10a and 10b, a sensor 12, a determining module 14 and a controlling module 16. The electromagnetic wave generators 10a and 10b are to generate an electromagnetic wave 11a and 11b respectively. In different embodiments, each of the electromagnetic waves 11a and 11b can be an infrared wave, a light signal, an ultrasonic wave or a radio wave. The number of the electromagnetic wave generators can be different in other embodiments according to different situations. If there is an object within the detection area, at least one reflected electromagnetic wave is generated according to the reflection of the electromagnetic waves 11a and 11b from the object within the detection area, wherein the number of the reflected electromagnetic wave is related to a displacing condition of the object. It's noticed that the detection area is varied according to the magnitude of the electromagnetic wave. Thus, by setting a greater magnitude of the electromagnetic wave generated by the electromagnetic wave generators, the detection area can be larger. The object described above can be a palm or a finger of the user, or even a pan or other object hold on the hand of the user. The displacing condition can be a displacing trajectory or a rest position of the object.

In the present embodiment, the sensor 12 is at the center of the two electromagnetic wave generators 10a and 10b. Thus the sensor 12 and the two electromagnetic wave generators are placed on the same line. The object 18 is rest in front of the sensor 12. The reflected electromagnetic wave 18a and 18b are generated according to the reflection of the electromagnetic waves 11a and 11b from the object 18. The sensor 12 is substantially an electromagnetic wave sensor to sense the reflected electromagnetic wave in an embodiment. In another embodiment, the sensor 12 is substantially an image sensor to sense the image formed by the reflected electromagnetic wave. No matter what kind of sensor described above, a sensing result 15 is generated by the sensor 12 according to the reflected electromagnetic wave 18a and 18b. It's noticed that the electromagnetic wave generators 10a and 10b generate the electromagnetic waves in order within a generating period. When the sensor doesn't detect the reflected electromagnetic wave after a plurality of generating periods, the plurality of electromagnetic wave generators lengthen a non-generating period between each of the generating periods in order to accomplish the power-saving.

The determining module 14 is to determine the displacing condition of the object 18 according to the sensing result 15. In the present embodiment, the determining module 14 determines that the object is rest in front of the sensor 12 according to the reflected electromagnetic wave 18a and 18b. The controlling module 16 is to generate a command 17 corresponding to the displacing condition according to a relation table 13 and further control an external electronic device 100 according to the command 17. The relation table 13 is substantially stored in the controlling module 16 to record different commands each corresponding to a displacing status. The number of the external electronic devices can be different in other embodiments. The remote sensing controller 1 further comprises a remote control module 102 to generate a remote control signal 101 to remotely reset the relation table 13 to modify the relation between the displacing condition and the command or to generate the command 17 directly, as depicted in FIG. 1B. According to command 17, the controlling module generates a digital or an analog signal to control the external electronic device 100. For example, in order to control an external electronic device such as a chip or a microprocessor, the digital signal is generated. In order to control an external electronic device such as a relay or a coil, the analog signal is generated. Both the digital and analog signals can be transferred to the external electronic device through a wireless technology.

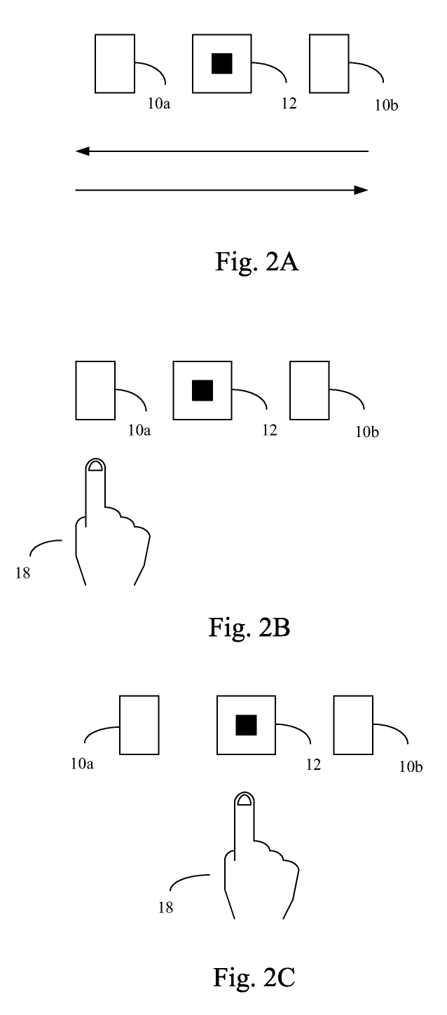

The electromagnetic generators 10a, 10b and the sensor 12 in the first embodiment can generate different commands according to various displacing status of the object. FIG. 2A depicts a displacing trajectory of an object from left to right and from right to left. FIG. 2B depicts a rest position in of an object front of the electromagnetic generators 10a. If the object is rest in front of the electromagnetic generators 10b, the command generated can be different from the command generated when the object is in front of the electromagnetic generators 10a. FIG. 2C depicts a rest position of the object 18 right in front of the sensor 12 to block the sensor 12. Thus, as described above, according to the arrangement of the electromagnetic generators 10a, 10b and the sensor 12 in the first embodiment, at least five different commands can be generated. It's noticed that each of the sensors of the conventional electromagnetic wave sensing device can only correspond to one electromagnetic wave generator. It takes five electromagnetic wave generators and five sensors to generate five commands. Thus, in contrast to the conventional electromagnetic wave sensing device, the electromagnetic wave sensing device of the present invention has much smaller cost and size.

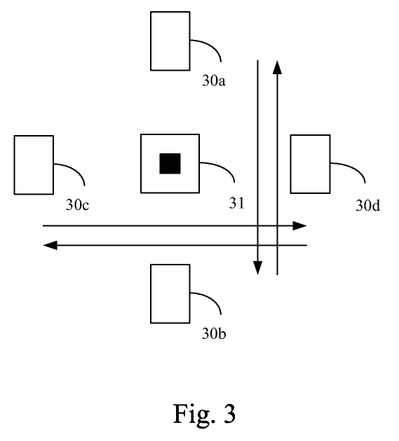

Please refer to FIG. 3. FIG. 3 is the electromagnetic wave generators and sensor of the second embodiment of the present invention. The determining module and the controlling module in the second embodiment are substantially the same as the first embodiment. However, four electromagnetic wave generators 30a, 30b, 30c, 30d and a sensor 31 are used in the second embodiment. The electromagnetic wave generators 30a, 30b, 30c, 30d are placed on the top, down, the left and the right sides of the sensor 31 respectively. More displacing status can be detected to generate more complex commands in the present embodiment. The sensor 31 can detect the trajectory of the object 32 such as the direction of right-left, left-right, top-down and bottom-up. Moreover, the detection of the diagonal directions and the rest positions related to the electromagnetic wave generators 30a, 30b, 30c, 30d provides more possibilities to generate different commands.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A remote sensing controller having a detection area, wherein the remote sensing controller comprises:
a plurality of electromagnetic wave generators to generate an electromagnetic wave respectively, wherein at least one reflected electromagnetic wave is further generated according to the reflection of the plurality of electromagnetic waves from an object within the detection area, wherein the number of the reflected electromagnetic wave is related to a displacing condition of the object;
a sensor to sense the reflected electromagnetic wave to generate a sensing result;
a determining module to determine the displacing condition of the object according to the sensing result; and
a controlling module to generate a command corresponding to the displacing condition according to a relation table and further control at least one external electronic device according to the command.

2. The remote sensing controller of claim 1, wherein the plurality of electromagnetic wave generators generate the electromagnetic waves in order within a generating period.

3. The remote sensing controller of claim 2, when the sensor doesn't detect the reflected electromagnetic wave after a plurality of generating periods, the plurality of electromagnetic wave generators lengthen a non-generating period between each of the generating periods.

4. The remote sensing controller of claim 1, wherein the detection area is varied according to the magnitude of the electromagnetic wave.

5. The remote sensing controller of claim 1, wherein the electromagnetic wave is an infrared wave, a light signal, an ultrasonic wave or a radio wave.

6. The remote sensing controller of claim 1, wherein the sensor is substantially an electromagnetic wave sensor to sense the reflected electromagnetic wave.

7. The remote sensing controller of claim 1, wherein the sensor is substantially an image sensor to sense the image formed by the reflected electromagnetic wave.

8. The remote sensing controller of claim 1, further comprising a remote control module to remotely reset the relation table to modify the relation between the displacing condition and the command.

9. The remote sensing controller of claim 8, wherein the remote control module is able to generate the command directly.

10. The remote sensing controller of claim 1, wherein the controlling module generates a digital signal according to the command to control the external electronic device.

11. The remote sensing controller of claim 10, wherein the digital signal is transferred to the external electronic device through a wireless technology.

12. The remote sensing controller of claim 1, wherein the controlling module generates an analog signal according to the command to control the external electronic device.

13. The remote sensing controller of claim 12, wherein the analog signal is transferred to the external electronic device through a wireless technology.

14. The remote sensing controller of claim 1, wherein the displacing condition is a displacing trajectory of the object.

15. The remote sensing controller of claim 1, wherein the displacing condition is a rest position of the object.
